(19) United States
(12) Patent Application Publication
(10) Pub. No.: US 2016/0271810 A1
(43) Pub. Date: Sep. 22, 2016

(54) Knife Whistle

(71) Applicant: Jean-Robert Charles Macgregor Cassie, Ottawa (CA)

(72) Inventor: Jean-Robert Charles Macgregor Cassie, Ottawa (CA)

(21) Appl. No.: 14/608,621

(22) Filed: Mar. 21, 2015

(51) Int. Cl. B26B 11/00; G10K 5/00

(52) U.S. Cl. CPC B26B 11/00; G10K 5/00

(57) ABSTRACT

The device is a combination of an inexpensive, disposable utility razor blade and a human breath powered audible noise making devide, or whistle. The disposable blade is held in place with a pin or other means and can easily be replaced with another blade. The whistle is integrated into the design to also act as the handle for the utility razor. The whistle designed is a tri-tone whistle that generates three distinct audible beat frequencies in order to create a distinct sound. The three primary frequencies are approximately 3 KHz but with slight differences in frequencies that generate a 30 Hz beat frequency between the two lowest frequencies and a 45 Hz beat frequency between the two highest frequencies. The difference between these beat frequencies generates a secondary beat frequency of 15 HZ.

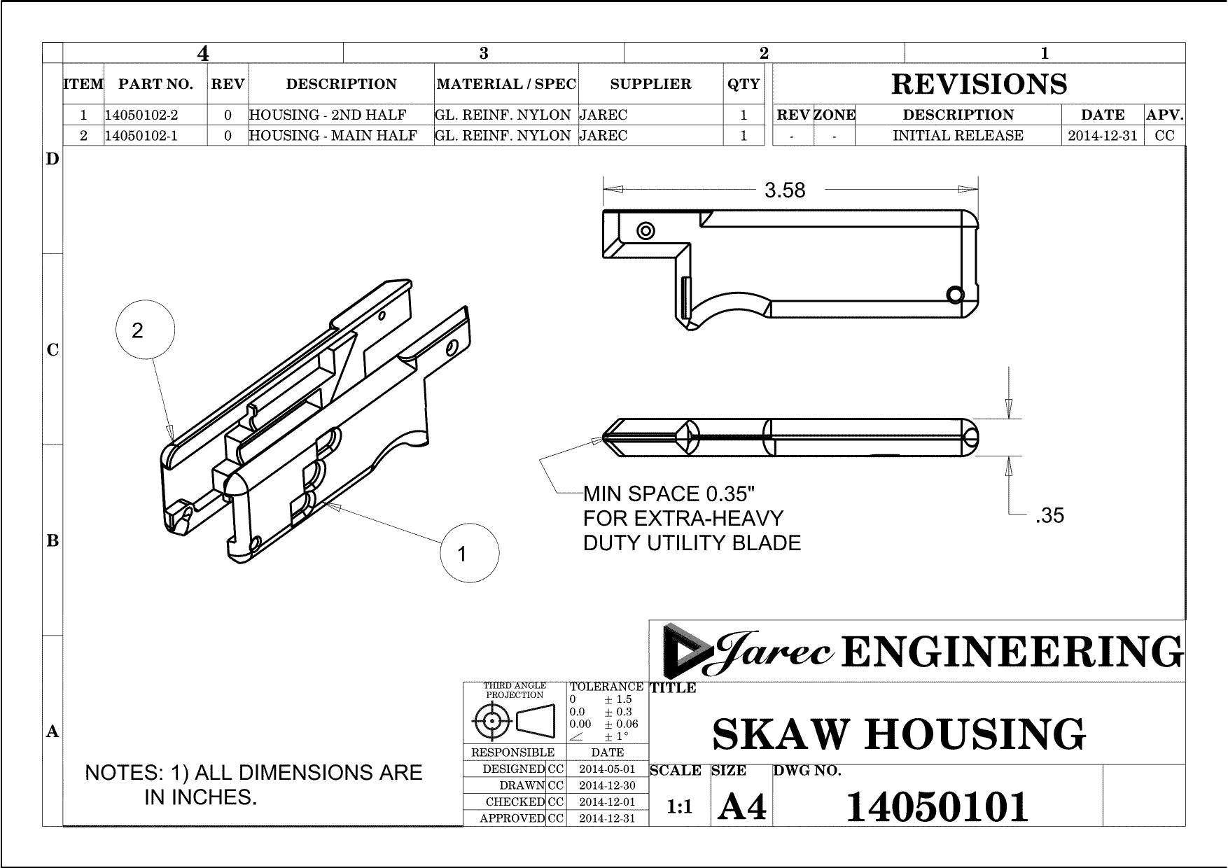

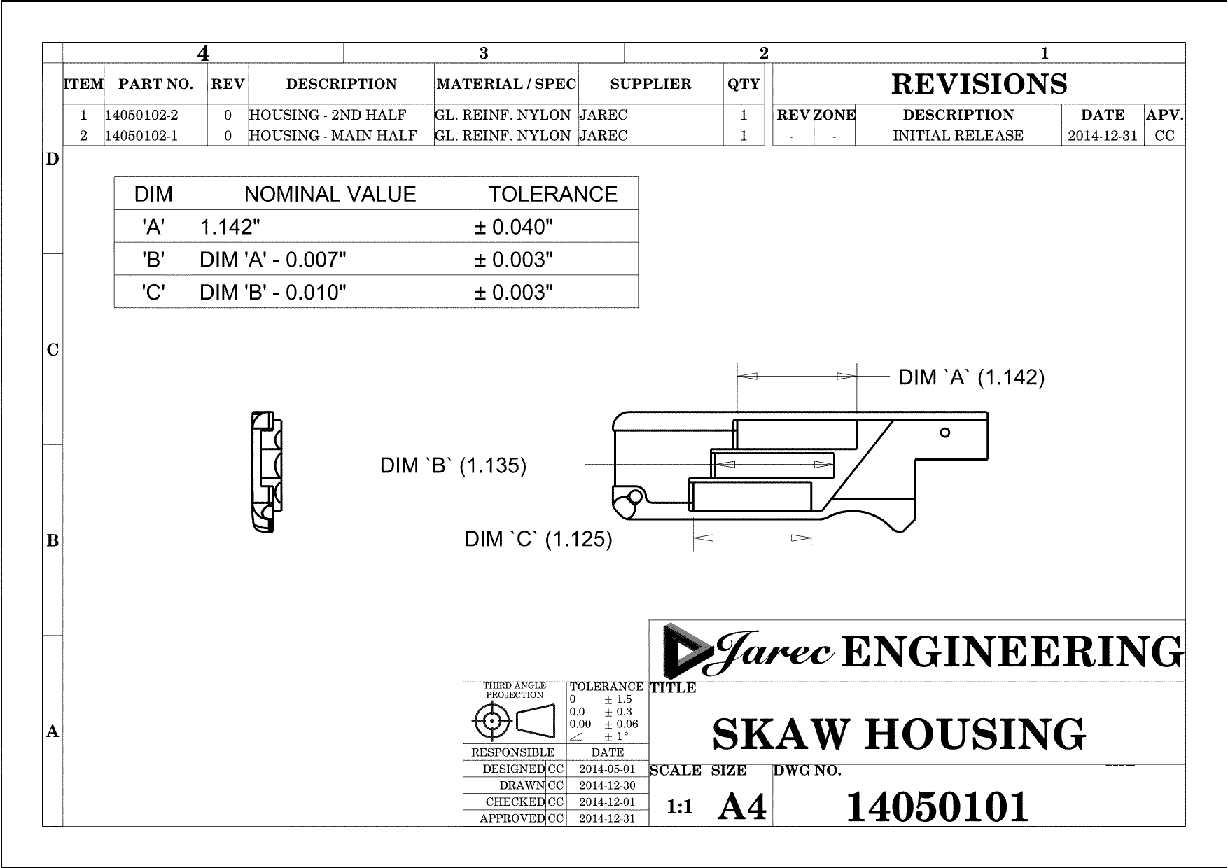

### RELATED APPLICATIONS

None.

### BACKGROUND OF THE INVENTION

The invention pertains generally to the noise making device acting as a means to hold a disposable utility razor blade.

Most wilderness survival kits contain: a) a utility razor blade; and b) a noise making device, or whistle. Such kits may contain a means of holding said utility razor blade for use, but some do not in order to save space.

Survival kits must be compact and lightweight in order to be capable of storage in a relatively small space, such as a pocket, or a fanny pack, or a woman's handbag or the glove box of a car.

Lastly, the razor blade in a survival kit must be shielded, or covered, in some manner, when not in use, so that the user is not accidentally hurt by the blade.

The invention utilizes the space already required for a noise making device as a handle to hold the utility razor blade that is typically found in survival kits. The additional space required to hold the utility razor blade is minimal while the necessary size for the whistle offers a handle of sufficient size to be useful and comfortable.

### DESCRIPTION OF THE INVENTION

The invention relates to a relatively simple, hand-held, noise making device that also acts as a handle for a utility razor blade. The handle is comfortable to hold and use, and is compact enough to fit into a woman's handbag or a pocket on an article of men's clothing.

The invention employs a tri-tone whistle with minor differences in the three tones in order to produce audible beat frequencies. Drawing 14050101 shows dimensions necessary to create beat frequencies of 33 Hz and 48 Hz. The beat frequencies themselves have minor differences in order to create a secondary audible beat frequency; in this case said secondary beat frequency is the difference between 48 Hz and 33 Hz, which is 15 Hz.

The invention also employs a retaining pin system in order to fix the utility razor blade in place in the body while retaining ease of replacement of said utility razor blade. The blade slides into the slot and is secured at the top, bottom, sides and back by the body. The pin is force-fit into place in order to secure the utility razor blade in place and can be removed to allow the blade to slide out of the body and be replaced.

The cap in claim 1 h) can be secured to the body using an elastic cord attached to the tip of the cap and the opposite end of the body. This will hold the cap onto the body and can be easily opened with one hand.

Furthermore, if the cap in claim 1 h) is not attached to the body but instead snaps onto the body and has a small hole at the end for a lanyard then it may be worn around the neck, offering quick access to both the whistle and the blade. This configuration can allow the whistle to be used as a safety whistle in urban settings and allows the blade to be used as an emergency defensive weapon. This configuration could be useful to deter potential assaults with the whistle while also allowing the user an immediately available means of self-defense.

### DESCRIPTION OF MANUFACTURING OF THE INVENTION

If only a few devices are required then the device can be 3D printed. The residual filaments may cause the whistle to operate inefficiently or not at all, depending on the quality of the print. Any imperfections in the interior walls of the body will be detrimental to the performance of the whistle.

The invention can be injection molded in parts, then sonically welded together. If the body is injection molded as per the parts shown in drawing 14050101, parts 14050102-1 and 14050102-2, then each part of said body can be injection molded without using slides or any other uncommon or complicated injection molding methods.

An alternative to sonic welding could be to mold a snap-together mechanism into the two parts. This would require sealing of the seams of the resonance chambers in order to prevent unwanted air leakage. This sealing could be done by dipping the assembled body into a sealant, but care must be taken to account for the thickness of the sealant in all design aspects.

### BRIEF DESCRIPTION OF THE DRAWINGS

Page 1 of drawing 14050101 contains a perspective view and projected views of the body in claim 1 a) and shows: a—the slot in claim 1 f) where the utility razor blade fits; b—the hole in claim 1 g) for the retaining pin that holds the utility razor blade in place; and c—the dimensional differences required for the resonance chambers in claim 1 b) in order to produce the 33 Hz and 48 Hz beat frequencies. The opening in claim 1 c) and the longitudinal slot in claim 1 f) are formed when part 14050102-1 and part 14050102-2 are joined.

Page 2 of drawing 14050101 shows the resonance chambers of claim 1 b) and claim 1 e) on part 14050102-2, and the outlets of the whistle in claim 1 d) on part 14050102-2.

1. A noise making device powered by human breath, comprising: a) a body made of a rigid material and sized to fit in the hand of a user; b) three resonance chambers of sllightly different lengths; c) a first opening at one end of said body which acts as a means of inlet air passage to said resonance chambers; d) three lateral openings that act as a means of outlet air passage and are positioned with the first side of each opening at the middle of the thickness the first wall of each resonance chamber; e) a small opening on the first wall of each resonance chamber, positioned at the beginning of said lateral openings, and on the same side as said lateral openings, to allow air flow passage; f) a longitudinal slot at the opposite end of said body as a means of holding a disposable utility razor blade having the bulk of the blade exposed and the entire top of the blade secured; g) a lateral hole at the top of said longitudinal slot to hold a retaining pin that secures the aforementioned utility razor blade; h) a cap covering the aforementioned utility razor blade at the end of said body.
